(19) United States
(12) Patent Application Publication
(10) Pub. No.: US 2010/0272881 A1
(43) Pub. Date: Oct. 28, 2010

(54) PYROPHOSPHATE-BASED COMPOSITIONS FOR USE IN MEAT PROCESSING

(76) Inventor: Eugene Brotsky, Elizabeth, NJ (US)

Correspondence Address: MCCARTER & ENGLISH, LLP HARTFORD;CITYPLACE I, 185 ASYLUM STREET, HARTFORD, CT, 06103, US

(21) Appl. No.: 12/430,535

(22) Filed: Apr. 27, 2009

(51) Int. Cl. A23B 4/027

(52) U.S. Cl. 426/652

(57) ABSTRACT

A highly alkaline pyrophosphate composition which allows meat processors to reduce total sodium while maintaining the desired properties of moisture retention, higher yield, and flavor protection. Moreover, the composition of the present invention dissolves well, thus avoiding the solubility problems associated with highly alkaline pyrophosphates.

### BACKGROUND OF THE INVENTION

(1) Field of the Invention

The present invention relates to the use of highly alkaline pyrophosphate-based compositions in meat.

Alkaline phosphates have long played an important role in the meat processing industry. They are formulated into meat products to achieve moisture retention, higher product yield, and flavor protection. Examples of these compounds include sodium tripolyphosphate (STP), sodium pyrophosphate (also known as tetrasodium pyrophosphate, hereinafter “TSPP”) and blends of these phosphates.

Presently, there is a need in the food industry to reduce sodium content in meat products as health-conscious consumers demand more reduced sodium products. However, decreasing the sodium content by reducing salt in meat has a negative effect on the moisture retention properties and subsequently product quality. Currently used alkaline phosphates can not achieve adequate moisture content in low sodium meats.

Alkaline pyrophosphates, particularly TSPP, combined with alkali are capable of retaining adequate moisture in low sodium meats. However, TSPP's use has been limited because of solubility problems: TSPP is difficult to dissolve and easily precipitates from solution in the presence of calcium and higher salt levels, causing equipment malfunction and quality issues.

Clearly, solving one problem creates another. Achieving the benefits of highly alkaline pyrophosphates requires that their problems be overcome before they can gain wide acceptance in the meat processing industry.

(2) Description of the Related Art

Sodium Tripolyphosphate (STP) with added alkali can achieve improved moisture retention. U.S. Pat. No. 3,104,978 (US'978) assigned to Hooker Chemical discloses solid alkali metal phosphate compositions useful in curing meat that are prepared by reacting an alkali metal tripolyphosphate (e.g. STP) with an alkali metal compound (e.g. NaOH). US' 978 maintained adequate moisture retention in standard hams (typically 2% or greater salt content) and avoided crystallization of the alkali metal phosphates in the meat. Prior to US'978, a phosphate pH of about 9.8. was used. US' 978 raised the pH to 10.5-12.0 and eliminated the problem of crystallization by using less phosphate composition. However, the US '978 technology cannot sufficiently overcome the negative moisture retention in low sodium meats.

U.S. Pat. No. 3,231,392 (US'392) assigned to Griffith Laboratories discloses a method of treating meat by simultaneously injecting 2 solutions into the meat. One solution has an enediol such as ascorbic acid or isoascorbic acid (erythorbic acid). The other solution is referred to as a high pH solution and it contains tri-alkali metal orthophosphates, alkali metal hydroxides and alkali metal carbonates. The US'392 disclosure does not describe a readily soluble composition that can overcome low moisture retention in low sodium meats.

Canadian Patent 878,423 ('423) assigned to Griffith Labs discloses a substantially non-reverted composition comprising STP and an alkali metal hydroxide (eg. NaOH). '423 recognizes that TSPP achieves higher water binding power but purposely avoids substantial reversion since it forms poorly-soluble TSPP. On the other hand, the composition of the present invention relies on TSPP combined with alkali to achieve the desired effects of higher water binding.

GB 1,218,081, January 1971, assigned to Griffith Labs, discloses a uniform meat-curing composition consisting of nitrite, STP or TSPP or NAOH. It does not disclose a powder containing TSPP and NAOH that dissolves well.

Knipe et al., Effects of Inorganic Phosphates and Sodium Hydroxide on Cooked, Cured, Color, pH and Emulsion Stability of Reduced Sodium and Conventional Meat Emulsions, Jnl of Food Science, 1305-1308 (1988), describes the effect on meat emulsions of adding NaOH to various inorganic phosphates (STP, TSPP, SAPP and SHMP). They do not disclose the preparation of a TSPP/NAOH powder that dissolves well.

It is well established that TSPP can achieve higher moisture retention in meat than STP. Now, Applicants have met long-felt needs in the meat processing industry by providing a highly alkaline pyrophosphate composition which allows manufacturers to reduce total sodium while maintaining the desired properties of moisture retention, higher yield, and flavor protection. Moreover, the composition of the present invention dissolves well and can avoid precipitation problems.

### BRIEF SUMMARY OF THE INVENTION

The present invention relates to a composition useful for preparing meat comprising:
a. 0 to 70 weight % of a non pyro alkali metal phosphate selected from the group consisting of STP, KTP, SHMP, TSP, DSP, DKP, their hydrates and mixtures thereof; and
b. 5 to 70 weight % of an alkali metal pyrophosphate selected from the group consisting of tetrasodium pyrophosphate, tetrapotassium pyrophosphate, trisodium pyrophosphate, their hydrates and mixtures thereof; and
c. 15 to 30 weight %, on an anhydrous basis, of a base selected from the group consisting of 50-100% NaOH, 45-100% KOH and 35% NH4 OH and mixtures thereof; and
d. 0 to 25 weight % water, added as solution water or as a chemical hydrate.
The present invention also relates to a composition useful for preparing meat comprising:
a. 0 to 70 weight % of a non pyro alkali metal phosphate selected from the group consisting of STP, KTP, SHMP, TSP, DSP, DKP, their hydrates and mixtures thereof; and
b. 5 to 70 weight % of an alkali metal pyrophosphate selected from the group consisting of tetrasodium pyrophosphate, tetrapotassium pyrophosphate, trisodium pyrophosphate, their hydrates and mixtures thereof; and
c. 15 to 30 weight %, on an anhydrous basis, of a base selected from the group consisting of 50-100% NaOH, 45-100% KOH, 35% NH4 OH, 10-100% sodium carbonate and 10-100% potassium carbonate and mixtures thereof; and
d. 0 to 25 weight % water, added as solution water or as a chemical hydrate.
The present invention further relates to a composition useful for preparing meat comprising:
a. 0 to 70 weight % of a non pyro alkali metal phosphates selected from the group consisting of STP, KTP, SHMP, TSP, DSP, DKP, their hydrates and mixtures thereof; and
b. 5 to 70 weight % of an alkali metal pyrophosphate selected from the group consisting of tetrasodium pyrophosphate, tetrapotassium pyrophosphate, disodium pyrophosphate, their hydrates and mixtures thereof; and
c. 15 to 30 weight %, on an anhydrous basis, of a base selected from the group consisting of 50-100% NaOH, 45-100% KOH and 35% NH4 OH and mixtures thereof; and
d. 0 to 25 weight % water, added as solution water or as a chemical hydrate, where in further, said composition is prepared according to the following steps:
   (a) Selecting one or more phosphates from the group consisting of STP, KTP, SHMP, TSP, DSP, DKP, tetrasodium pyrophosphate, tetrapotassium pyrophosphate, trisodium pyrophosphate, their hydrates and mixtures thereof; and
   (b) Spraying a base selected from the group consisting of 50-100% NaOH, 45-100% KOH and 35% NH4 OH and mixtures thereof into the phosphate(s) selected in step (a)
   (c) Mixing the result of step (b) until a uniform powder is achieved.
The present invention further relates to a composition useful for preparing meat comprising:
a. 0 to 70 weight % of a non pyro alkali metal phosphates selected from the group consisting of STP, KTP, SHMP, TSP, DSP, DKP, their hydrates and mixtures thereof; and
b. 5 to 70 weight % of an alkali metal pyrophosphate selected from the group consisting of tetrasodium pyrophosphate, tetrapotassium pyrophosphate, disodium pyrophosphate, their hydrates and mixtures thereof; and
c. 15 to 30 weight %, on an anhydrous basis, of a base selected from the group consisting of 50-100% NaOH, 45-100% KOH, 35% NH4 OH, 10-100% sodium carbonate and 10-100% potassium carbonate and mixtures thereof; and
d. 0 to 25 weight % water, added as solution water or as a chemical hydrate, where in further, said composition is prepared according to the following steps:
   (a) Selecting one or more phosphates from the group consisting of STP, KTP, SHMP, TSP, DSP, DKP, tetrasodium pyrophosphate, tetrapotassium pyrophosphate, trisodium pyrophosphate, their hydrates and mixtures thereof; and
   (b) Spraying a base selected from the group consisting of 50-100% NaOH, 45-100% KOH, 35% NH4 OH, 10-100% sodium carbonate and 10-100% potassium carbonate and mixtures thereof into the phosphate(s) selected in step (a)
   (c) Mixing the result of step (b) until a uniform powder is achieved.

The following terms have the following meaning herein:

Meat means any animal-derived food product, including, but not limited to, beef, buffalo, wild game, lamb, veal, pork, poultry, fish and shellfish.

STP means sodium tripolyphosphate

TSPP means tetrasodium pyrophosphate. Synonyms for TSPP are sodium pyrophosphate and tetrasodium diphosphate.

DSP means disodium phosphate.

DSPA means disodium phosphate anhydrous

The term “highly alkaline means having a pH greater than or equal to 12.

KTP means potassium tripolyphosphate.

SHMP means sodium hexametaphosphate.

TSP means trisodium phosphate.

DKP means dipotassium phosphate.

The term “solution water” means water that is added as part of a solution, in other words, water that is not added separately.

“Pickle liquor” means the solution consisting of salt, phosphate and other ingredients used for curing or marinating meats.

The term “chemical hydrate” means that the host molecule has added water, chemically bound.

The term “non pyro alkali metal phosphates” means compounds selected from the group including, but not limited to, STP, KTP, SHMP, TSP, DSP, DKP, their hydrates and mixtures thereof.

The term “uniform powder” means a powder wherein the pH range varies no more than 0.3 pH units from the mean of a 1% solution.

The term “alkali carbonate” means sodium carbonate and potassium carbonate

### DETAILED DESCRIPTION OF THE INVENTION.

The present invention relates to a composition useful for preparing meat comprising:
a. 0 to 70 weight % of a non pyro alkali metal phosphate selected from the group consisting of STP, KTP, SHMP, TSP, DSP, DKP, their hydrates and mixtures thereof; and
b. 5 to 70 weight % of an alkali metal pyrophosphate selected from the group consisting of tetrasodium pyrophosphate, tetrapotassium pyrophosphate, trisodium pyrophosphate, their hydrates and mixtures thereof; and
c. 15 to 30 weight %, on an anhydrous basis, of a base selected from the group consisting of 50-100% NaOH, 45-100% KOH and 35% NH4 OH and mixtures thereof; and
e. 0 to 25 weight % water, added as solution water or as a chemical hydrate.
The present invention also relates to a composition useful for preparing meat comprising:
a. 0 to 70 weight % of a non pyro alkali metal phosphate selected from the group consisting of STP, KTP, SHMP, TSP, DSP, DKP, their hydrates and mixtures thereof; and
b. 5 to 70 weight % of an alkali metal pyrophosphate selected from the group consisting of tetrasodium pyrophosphate, tetrapotassium pyrophosphate, trisodium pyrophosphate, their hydrates and mixtures thereof; and
c. 15 to 30 weight %, on an anhydrous basis, of a base selected from the group consisting of 50-100% NaOH, 45-100% KOH, 35% NH4 OH, 10-100% sodium carbonate and 10-100% potassium carbonate and mixtures thereof; and
d. 0 to 25 weight % water, added as solution water or as a chemical hydrate.
The present invention further relates to a composition useful for preparing meat comprising:
a. 0 to 70 weight % of a non pyro alkali metal phosphates selected from the group consisting of STP, KTP, SHMP, TSP, DSP, DKP, their hydrates and mixtures thereof; and
b. 5 to 70 weight % of an alkali metal pyrophosphate selected from the group consisting of tetrasodium pyrophosphate, tetrapotassium pyrophosphate, disodium pyrophosphate, their hydrates and mixtures thereof; and
c. 15 to 30 weight %, on an anhydrous basis, of a base selected from the group consisting of 50-100% NaOH, 45-100% KOH and 35% NH4 OH and mixtures thereof; and
d. 0 to 25 weight % water, added as solution water or as a chemical hydrate, where in further, said composition is prepared according to the following steps:
   (a) Selecting one or more phosphates from the group consisting of STP, KTP, SHMP, TSP, DSP, DKP, tetrasodium pyrophosphate, tetrapotassium pyrophosphate, trisodium pyrophosphate, their hydrates and mixtures thereof; and
   (b) Spraying a base selected from the group consisting of 50-100% NaOH, 45-100% KOH and 35% NH4 OH and mixtures thereof into the phosphate(s) selected in step (a)
   (c) Mixing the result of step (b) until a uniform powder is achieved.
The present invention further relates to a composition useful for preparing meat comprising:
a. 0 to 70 weight % of a non pyro alkali metal phosphates selected from the group consisting of STP, KTP, SHMP, TSP, DSP, DKP, their hydrates and mixtures thereof; and
b. 5 to 70 weight % of an alkali metal pyrophosphate selected from the group consisting of tetrasodium pyrophosphate, tetrapotassium pyrophosphate, disodium pyrophosphate, their hydrates and mixtures thereof; and
c. 15 to 30 weight %, on an anhydrous basis, of a base selected from the group consisting of 50-100% NaOH, 45-100% KOH, 35% NH4 OH, 10-100% sodium carbonate and 10-100% potassium carbonate and mixtures thereof; and
d. 0 to 25 weight % water, added as solution water or as a chemical hydrate, where in further, said composition is prepared according to the following steps:
   (a) Selecting one or more phosphates from the group consisting of STP, KTP, SHMP, TSP, DSP, DKP, tetrasodium pyrophosphate, tetrapotassium pyrophosphate, trisodium pyrophosphate, their hydrates and mixtures thereof; and
   (b) Spraying a base selected from the group consisting of 50-100% NaOH, 45-100% KOH, 35% NH4 OH, 10-100% sodium carbonate and 10-100% potassium carbonate and mixtures thereof into the phosphate(s) selected in step (a)
   (c) Mixing the result of step (b) until a uniform powder is achieved.

The Non Pyro Alkali Metal Phosphates

Non-pyro alkali metal phosphates are optional ingredients in the present invention. However, if desired, non-pyro alkali metal phosphates useful in the practice of the present invention include, but are not limited to, STP, KTP, SHMP, TSP, DSP, DKP, their hydrates and mixtures thereof. In an embodiment of the invention, STP and KTP are preferred.

Said non pyro alkali metal phosphates are used at a level of 0-70 weight %. In another embodiment said non pyro alkali metal phosphates are used at a level of 15 to 65 weight %. In yet another embodiment said non pyro alkali metal phosphates are used at a level of 35 to 65 weight %.

The Alkali Metal Pyrophosphates

Alkali metal pyrophosphates useful in the practice of the present invention include, but are not limited to, tetrasodium pyrophosphate, tetrapotassium pyrophosphate, trisodium pyrophosphate, their hydrates and mixtures thereof. In an embodiment of the invention, tetrasodium pyrophosphate and tetrapotassium pyrophosphate are preferred.

Said alkali metal pyrophosphates are used at a level of 5-70 weight %. In another embodiment said alkali metal pyrophosphates are used at a level of 15-70 weight %. In yet another embodiment said alkali metal pyrophosphates are used at a level of 15-35 weight %.

The Bases

Bases useful in the practice of the present invention include, but are not limited to, 50-100% NaOH, 45-100% KOH, 35% NH4 OH, 10-100% sodium carbonate, and 10-100% potassium carbonate , and mixtures thereof. In an embodiment of the invention 50-75% NaOH, 45-75% KOH, and 10-20% sodium carbonate are the preferred bases. In yet another embodiment, 50% NaOH and 50% KOH are preferred bases.

Said bases are used at a level of 15-30 weight % on an anhydrous basis. In another embodiment said bases are used at a level of 15-25 weight % on an anhydrous basis. In yet another embodiment said bases are used at a level of 15-20 weight % on an anhydrous basis.

Finally, water is an optional ingredient in the composition of the present invention. If added, water can be added as solution water or as a chemical hydrate. The solution may be used to dissolve one of the components, for example, sodium hydroxide. Alternatively, chemical hydration water may be added, for example, DSP duohydrate.

Water may be used at a level of 0 to 25 weight %. In another embodiment water may be used at a level of 10-25 weight %. In yet another embodiment water may be used at a level of 15-20 weight %.

The composition of the present invention is prepared by methods known to those skilled in the art. Said methods involve spraying and mixing. In an embodiment of the invention, the composition is prepared accordingly: the base is sprayed onto phosphates selected from the group, including but not limited to, STP, KTP, SHMP, TSP, DSP, DKP, tetrasodium pyrophosphate, tetrapotassium pyrophosphate, trisodium pyrophosphate, their hydrates and mixtures thereof. These base sprayed phosphates are then mixed until a uniform powder is achieved.

In an embodiment of the invention, the composition is prepared in two steps, liquid-solids blending and solids mixing as follows:
1. Step One: Rapid spraying of a base, for example, 50% NaOH, onto the phosphates, while mixing at low to medium shear, at room temperature and a residence time from 5 seconds-instant to 5 minutes.
2. Step Two: Continuously transferring the Step One mixture into a rotary mixer, rotary tube (kiln or cooler) supplied with a counter-current or co-current air flow at room temperature, or process equipment supplied with various mixing devices to continue mixing at room temperature or from 10° C. to 35° C.; for a time period from 4 to 76 minutes, at low rotational speed from 2.39 rpm to 25 rpm (for a tumbler, rotary double-cone mixer, kiln/cooler, drum agglomerator), or from 0.67 m/s to 0.8 m/s for mixers supplied with mixing devices.
   One skilled in the art understands that the equipment used to prepare the composition can include, but is not limited to, tumblers and/or mixers with internal moving mixing devices, such as twin shell liquid-solids tumbler, drum agglomerators, liquid-solids blenders, solids mixers, plow mixers, disc/drum agglomerators, and rotary double-cone mixers.

The following non limiting examples illustrate the practice of the present invention and its utility.

### EXAMPLE 1

### Process for Preparing the Present Invention

To prepare a 3.627 kg batch of the composition of the present invention a Twin Shell Tumbler with a Liquid-Solids Intensifier Bar was used.
1. The phosphate solids, charged in the blender, were tumbled (mixed) for 5 minutes at 25 rpm.
2. Sodium hydroxide was sprayed onto said phosphate solids for 3 minutes (180 seconds) at a rate of 0.4 kg/min with the bar at 3300 fpm (16.8 m/s), and shell at 25 rpm.
3. Tumbling of the base sprayed phosphates was carried out for 3 minutes at a shell rotational speed of 25 rpm, and temperature peak of 91.3° F. (32.9° C.).
4. The product was transferred in a Pan Agglomerator (Disc or Drum Pelletizer) at room temperature, with a rotational speed of 20 rpm, and a 20° angle. The material was mixed at low speed for 25 minutes and discharged at 86.3° F. (30.17° C.). A uniform powder was produced wherein the pH range of a 1% solution of said powder varied no more than 0.3 pH units from the mean pH of a 1% solution of said powder.

### EXAMPLE 2

Compositions are prepared as in Example 1 with the following % components:

| Composition | STP | TSPP | TKPP | 50% NAOH |
|---|---|---|---|---|
| A | | 50 | 17 | 33 |
| B | 17 | 33 | 17 | 33 |
| C | 67 | | | 33 |
| D | | 67 | | 33 |
| E | 33.5 | 33.5 | | 33 |

One skilled in the art understands that any calculations involving bases must account for the product composition. In other words, what percentage is water? Thus, for the avoidance of doubt, Applicants respectfully present the following calculation to illustrate how the anhydrous base falls within the scope of the claims. For example: Take 60 g of a composition of the present invention which contains 33% (as described in Table 2) of a 50% NAOH solution. Multiply 33%×60 g=20 g. On an anhydrous basis the 20 g contains 10 g solid NAOH and 10 g water. For the product on an anydrous basis we subtract 10 g water=50 g solids. 10 g solid NAOH/50 g=20% NAOH anhydrous basis, which is within our embodied range of 15-20%.

### EXAMPLE 3

50 g TSPP and 58 g of Compositions A and B were dissolved in 1000 g water using a propeller run at 400 RPM. The higher additions for A and B account for the added water in the composition, so that identical solids are added as for TSPP. Times for complete dissolution at room temperature were recorded:

| | Dissolve Time |
|---|---|
| Composition | (sec) |
| TSPP | 420 |
| A | 135 |
| B | 120 |

Dissolve times for the compositions of the present invention were considerably faster than TSPP alone. Not wishing to be bound by theory, the alkali (i.e base) activates the TSPP to a quick dissolving form.

### EXAMPLE 4

Composition A—Pork loins were ground and mixed. 2000 g meat were mixed with 1500 g of solution containing 1.37% Composition A and 1.75% salt.

Composition B—Pork loins were ground and mixed. 2000 g meat were mixed with 1500 g of solution containing 1.37% Composition B and 1.75% salt.

One set of 400 g amounts was packed in foil pans, stored for 3 hr. and cooked. The remaining set were stored overnight and cooked.

% Cook Yield

| Composition | 3 hr hold | 22 hr hold |
|---|---|---|
| A | 86.5 | 89.5 |
| B | 89.7 | 93 |

### EXAMPLE 5

Chicken breasts were ground and processed as in Example 4 with Compositions C, D and E

% Cook Yield

| Composition | 3 hr hold | 22 hr hold |
|---|---|---|
| C | 71.4 | 75 |
| D | 79.7 | 82.6 |
| E | 72 | 80.3 |

Composition C is similar to compositions disclosed in the Hooker Chemical patent, U.S. Pat. No. 3,104,978.

Results for Examples 3 and 4 show that compositions containing TSPP achieve higher yields than those made with STP alone.

### EXAMPLE 6

Pork loins were injected to 25-30% extension(every 1 Og was extended to 125-130 g) with solutions containing either 1.93% STP and 3.86% salt, 1.93% STP and 7.72% salt or 2.24% Composition D and 1.93% salt. All solutions contained 0.062% sodium nitrite. Additional solution was added to each loin set in a tumbler equivalent to a total 35% extension. Loins were tumbled for 3 hrs; they were stuffed into casings and one set was cooked. The other set was stored overnight and cooked.

% Cook Yield

| Composition | % Salt in Ham | 3 hr hold | 22 hr hold |
|---|---|---|---|
| STP | 1 | 66 | 65.8 |
| STP | 2 | 76.8 | 76.8 |
| D | 0.5 | 78 | 77.9 |

Results show that 2% salt is required to achieve acceptable ham yields using STP. Composition D achieves similar yields using only 0.5% salt, a 75% reduction in salt and sodium level.

We claim:

1. A composition useful for preparing meat comprising:
a. 0 to 70 weight % of a non pyro alkali metal phosphate selected from the group consisting of STP, KTP, SHMP, TSP, DSP, DKP, their hydrates and mixtures thereof; and
b. 5 to 70 weight % of an alkali metal pyrophosphate selected from the group consisting of tetrasodium pyrophosphate, tetrapotassium pyrophosphate, trisodium pyrophosphate, their hydrates and mixtures thereof; and
c. 15 to 30 weight % on an anhydrous basis, of a base selected from the group consisting of 50-100% NaOH, 45-100% KOH and 35% NH4 OH and mixtures thereof; and
d. 0 to 25 weight % water, added as solution water or as a chemical hydrate.

2. A composition useful for preparing meat comprising:
a. 0 to 70 weight % of a non pyro alkali metal phosphate selected from the group consisting of STP, KTP, SHMP, TSP, DSP, DKP, their hydrates and mixtures thereof; and
b. 5 to 70 weight % of an alkali metal pyrophosphate selected from the group consisting of tetrasodium pyrophosphate, tetrapotassium pyrophosphate, trisodium pyrophosphate, their hydrates and mixtures thereof; and
c. 15 to 30 weight % ,on an anhydrous basis, of a base selected from the group consisting of 50-100% NaOH, 45-100% KOH, 35% NH4 OH, 10-100% sodium carbonate and 10-100% potassium carbonate and mixtures thereof; and
d. 0 to 25 weight % water, added as solution water or as a chemical hydrate.

3. A composition useful for preparing meat comprising:
a. 0 to 70 weight % of a non pyro alkali metal phosphate selected from the group consisting of STP, KTP, SHMP, TSP, DSP, DKP, their hydrates and mixtures thereof; and
b. 5 to 70 weight % of an alkali metal pyrophosphate selected from the group consisting of tetrasodium pyrophosphate, tetrapotassium pyrophosphate, disodium pyrophosphate, their hydrates and mixtures thereof; and
c. 15 to 30 weight % on an anhydrous basis, of a base selected from the group consisting of 50-100% NaOH, 45-100% KOH and 35% NH4 OH and mixtures thereof; and
d. 0 to 25 weight % water, added as solution water or as a chemical hydrate, where in further, said composition is prepared according to the following steps:
(a) Selecting one or more phosphates from the group consisting of STP, KTP, SHMP, TSP, DSP, DKP, tetrasodium pyrophosphate, tetrapotassium pyrophosphate, trisodium pyrophosphate, their hydrates and mixtures thereof; and
(b) Spraying a base selected from the group consisting of 50-100% NaOH, 45-100% KOH and 35% NH4 OH and mixtures thereof into the phosphate(s) selected in step (a)
(c) Mixing the result of step (b) until a uniform powder is achieved.

4. A composition useful for preparing meat comprising:
a. 0 to 70 weight % of a non pyro alkali metal phosphate selected from the group consisting of STP, KTP, SHMP, TSP, DSP, DKP, their hydrates and mixtures thereof; and
b. 5 to 70 weight % of an alkali metal pyrophosphate selected from the group consisting of tetrasodium pyrophosphate, tetrapotassium pyrophosphate, disodium pyrophosphate, their hydrates and mixtures thereof; and
c. 15 to 30 weight % ,on an anhydrous basis, of a base selected from the group consisting of 50-100% NaOH, 45-100% KOH, 35% NH4 OH, 10-100% sodium carbonate and 10-100% potassium carbonate and mixtures thereof; and
d. 0 to 25 weight % water, added as solution water or as a chemical hydrate, where in further, said composition is prepared according to the following steps:
(a) Selecting one or more phosphates from the group consisting of STP, KTP, SHMP, TSP, DSP, DKP, tetrasodium pyrophosphate, tetrapotassium pyrophosphate, trisodium pyrophosphate, their hydrates and mixtures thereof; and
(b) Spraying a base selected from the group consisting of 50-100% NaOH, 45-100% KOH, 35% NH4 OH, 10-100% sodium carbonate and 10-100% potassium carbonate and mixtures thereof into the phosphate(s) selected in step (a)
(c) Mixing the result of step (b) until a uniform powder is achieved.

5. A composition useful for preparing meat comprising:
a. 15 to 65 weight % of a non pyro alkali metal phosphate selected from the group consisting of STP, KTP, SHMP, TSP, DSP, DKP, their hydrates and mixtures thereof; and
b. 15 to 70 weight % of an alkali metal pyrophosphate selected from the group consisting of tetrasodium pyrophosphate, tetrapotassium pyrophosphate, trisodium pyrophosphate, their hydrates and mixtures thereof; and
c. 15 to 25 weight %, on an anhydrous basis, of a base selected from the group consisting of 50-100% NaOH, 45-100% KOH and 35% NH4 OH and mixtures thereof; and
d. 10 to 25 weight % water, added as solute water or as a chemical hydrate.

6. A composition useful for preparing meat comprising:
a. 15 to 65 weight % of a non pyro alkali metal phosphate selected from the group consisting of STP, KTP, SHMP, TSP, DSP, DKP, their hydrates and mixtures thereof; and
b. 15 to 70 weight % of an alkali metal pyrophosphate selected from the group consisting of tetrasodium pyrophosphate, tetrapotassium pyrophosphate, trisodium pyrophosphate, their hydrates and mixtures thereof; and
c. 15 to 25 weight %, on an anhydrous basis, of a base selected from the group consisting of 50-100% NaOH, 45-100% KOH, 35% NH4 OH, 10-100% sodium carbonate and 10-100% potassium carbonate and mixtures thereof and
d. 10 to 25 weight % water, added as solute water or as a chemical hydrate

7. A composition useful for preparing meat comprising:
a. 15 to 65 weight % of a non pyro alkali metal phosphate selected from the group consisting of STP, KTP, SHMP, TSP, DSP, DKP, their hydrates and mixtures thereof; and
b. 15 to 70 weight % of an alkali metal pyrophosphate selected from the group consisting of tetrasodium pyrophosphate, tetrapotassium pyrophosphate, disodium pyrophosphate, their hydrates and mixtures thereof; and
c. 15 to 25 weight %, on an anhydrous basis, of a base selected from the group consisting of 50-100% NaOH, 45-100% KOH and 35% NH4 OH and mixtures thereof; and
d. 10 to 25 weight % water, added as solute water or as a chemical hydrate, where in further, said composition is prepared according to the following steps:
(a) Selecting one or more phosphates from the group consisting of STP, KTP, SHMP, TSP, DSP, DKP, tetrasodium pyrophosphate, tetrapotassium pyrophosphate, trisodium pyrophosphate, their hydrates and mixtures thereof; and
(b) Spraying a base selected from the group consisting of 50-100% NaOH, 45-100% KOH and 35% NH4 OH and mixtures thereof into the phosphate(s) selected in step (a)
(c) Mixing the result of step (b) until a uniform powder is achieved.

8. A composition useful for preparing meat comprising:
a. 15 to 65 weight % of a non pyro alkali metal phosphate selected from the group consisting of STP, KTP, SHMP, TSP, DSP, DKP, their hydrates and mixtures thereof; and
b. 15 to 70 weight % of an alkali metal pyrophosphate selected from the group consisting of tetrasodium pyrophosphate, tetrapotassium pyrophosphate, disodium pyrophosphate, their hydrates and mixtures thereof; and
c. 15 to 25 weight %, on an anhydrous basis, of a base selected from the group consisting of 50-100% NaOH, 45-100% KOH, 35% NH4 OH, 10-100% sodium carbonate, and 10-100% potassium carbonate and mixtures thereof; and
d. 10 to 25 weight % water, added as solute water or as a chemical hydrate, where in further, said composition is prepared according to the following steps:
(a) Selecting one or more phosphates from the group consisting of STP, KTP, SHMP, TSP, DSP, DKP, tetrasodium pyrophosphate, tetrapotassium pyrophosphate, trisodium pyrophosphate, their hydrates and mixtures thereof; and
(b) Spraying a base selected from the group consisting of 50-100% NaOH, 45-100% KOH and 35% NH4 OH, 10-100% sodium carbonate, and 10-100% potassium carbonate and mixtures thereof into the phosphate(s) selected in step (a)
(c) Mixing the result of step (b) until a uniform powder is achieved.

9. A composition useful for preparing meat comprising:
a. 35 to 65 weight % of a non pyro alkali metal phosphates selected from the group consisting of STP, KTP, SHMP, TSP, DSP, DKP, their hydrates and mixtures thereof; and
b. 15 to 35 weight % of an alkali metal pyrophosphate selected from the group consisting of tetrasodium pyrophosphate, tetrapotassium pyrophosphate, trisodium pyrophosphate, their hydrates and mixtures thereof; and
c. 15 to 20 weight %, on an anhydrous basis, of a base selected from the group consisting of 50-100% NaOH, 45-100% KOH and 35% NH4 OH and mixtures thereof; and
d. 15 to 20 weight % water, added as solute water or as a chemical hydrate.

10. A composition useful for preparing meat comprising:
a. 35 to 65 weight % of a non pyro alkali metal phosphates selected from the group consisting of STP, KTP, SHMP, TSP, DSP, DKP, their hydrates and mixtures thereof; and
b. 15 to 35 weight % of an alkali metal pyrophosphate selected from the group consisting of tetrasodium pyrophosphate, tetrapotassium pyrophosphate, trisodium pyrophosphate, their hydrates and mixtures thereof; and
c. 15 to 20 weight %, on an anhydrous basis, of a base selected from the group consisting of 50-100% NaOH, 45-100% KOH and 35% NH4 OH, 10-100% sodium carbonate, and 10-100% potassium carbonate, and mixtures thereof; and
d. 15 to 20 weight % water, added as solute water or as a chemical hydrate.

11. A composition useful for preparing meat comprising:
a. 35 to 65 weight % of a non pyro alkali metal phosphate selected from the group consisting of STP, KTP, SHMP, TSP, DSP, DKP, their hydrates and mixtures thereof; and
b. 15 to 35 weight % of an alkali metal pyrophosphate selected from the group consisting of tetrasodium pyrophosphate, tetrapotassium pyrophosphate, disodium pyrophosphate, their hydrates and mixtures thereof; and
c. 15 to 20 weight %, on an anhydrous basis, of a base selected from the group consisting of 50-100% NaOH, 45-100% KOH and 35% NH4 OH and mixtures thereof; and
d. 15 to 20 weight % water, added as solute water or as a chemical hydrate, where in further, said composition is prepared according to the following steps:
(a) Selecting one or more phosphates from the group consisting of STP, KTP, SHMP, TSP, DSP, DKP, tetrasodium pyrophosphate, tetrapotassium pyrophosphate, trisodium pyrophosphate, their hydrates and mixtures thereof; and
(b) Spraying a base selected from the group consisting of 50-100% NaOH, 45-100% KOH and 35% NH4 OH and mixtures thereof into the phosphate(s) selected in step (a)
(c) Mixing the result of step (b) until a uniform powder is achieved, such that any portion of the mixture has the same pH.

12. A composition useful for preparing meat comprising:
a. 35 to 65 weight % of a non pyro alkali metal phosphate selected from the group consisting of STP, KTP, SHMP, TSP, DSP, DKP, their hydrates and mixtures thereof; and
b. 15 to 35 weight % of an alkali metal pyrophosphate selected from the group consisting of tetrasodium pyrophosphate, tetrapotassium pyrophosphate, disodium pyrophosphate, their hydrates and mixtures thereof; and
c. 15 to 20 weight %, on an anhydrous basis, of a base selected from the group consisting of 50-100% NaOH, 45-100% KOH and 35% NH4 OH, 10-100% sodium carbonate and 10-100% potassium carbonate, and mixtures thereof; and
d. 15 to 20 weight % water, added as solute water or as a chemical hydrate, where in further, said composition is prepared according to the following steps:
(a) Selecting one or more phosphates from the group consisting of STP, KTP, SHMP, TSP, DSP, DKP, tetrasodium pyrophosphate, tetrapotassium pyrophosphate, trisodium pyrophosphate, their hydrates and mixtures thereof; and
(b) Spraying a base selected from the group consisting of 50-100% NaOH, 45-100% KOH, 35% NH4 OH, 10-100% sodium carbonate and 10-100% potassium carbonate and mixtures thereof into the phosphate(s) selected in step (a)
(c) Mixing the result of step (b) until a uniform powder is achieved, such that any portion of the mixture has the same pH.

13. A composition useful for preparing meat comprising:
a. 0 to 70 weight % of a non pyro alkali metal phosphate selected from the group consisting of STP, KTP, SHMP, TSP, DSP, DKP, their hydrates and mixtures thereof; and
b. 5 to 70 weight % of an alkali metal pyrophosphate selected from the group consisting of tetrasodium pyrophosphate, tetrapotassium pyrophosphate, trisodium pyrophosphate, their hydrates and mixtures thereof; and
c. 15 to 30 weight % ,on an anhydrous basis, of a base selected from the group consisting of 50-75% NaOH, 45-75% KOH, 35% NH4 OH, 10-20% sodium carbonate and 10-20% potassium carbonate and mixtures thereof; and
d. 0 to 25 weight % water, added as solution water or as a chemical hydrate.

14. A composition useful for preparing meat comprising:
a. 0 to 70 weight % of a non pyro alkali metal phosphate selected from the group consisting of STP, KTP, SHMP, TSP, DSP, DKP, their hydrates and mixtures thereof; and
b. 5 to 70 weight % of an alkali metal pyrophosphate selected from the group consisting of tetrasodium pyrophosphate, tetrapotassium pyrophosphate, disodium pyrophosphate, their hydrates and mixtures thereof; and
c. 15 to 30 weight % on an anhydrous basis, of a base selected from the group consisting of 50-75% NaOH, 45-75% KOH, 35% NH4 OH, 10-20% sodium carbonate and 10-20% potassium carbonate and mixtures thereof; and
d. 0 to 25 weight % water, added as solution water or as a chemical hydrate, where in further, said composition is prepared according to the following steps:
(a) Selecting one or more phosphates from the group consisting of STP, KTP, SHMP, TSP, DSP, DKP, tetrasodium pyrophosphate, tetrapotassium pyrophosphate, trisodium pyrophosphate, their hydrates and mixtures thereof; and
(b) Spraying a base selected from the group consisting of 50-75% NaOH, 45-75% KOH, 35% NH4 OH, 10-20% sodium carbonate and 10-20% potassium carbonate and mixtures thereof into the phosphate(s) selected in step (a)
(c) Mixing the result of step (b) until a uniform powder is achieved.

15. A composition according to claim 1, wherein said water comprises 0 weight % of said composition and said non pyro alkali metal phosphate comprises 0 weight % of said composition.

16. A composition comprising:
a. 67% by weight TSPP
b. 33% by weight 50% NaOH, on an anhydrous basis.

17. A composition comprising:
a. 67% by weight TSPP
b. 33% by weight of 50% NaOH, on an anhydrous basis, wherein further, said composition is prepared according to the following steps:
(a) Spraying said 50% NaOH into said TSPP;
(b) Mixing the result of step (a) until a uniform powder is achieved.
